(19) United States
(12) Patent Application Publication
(10) Pub. No.: US 2009/0037267 A1
(43) Pub. Date: Feb. 5, 2009

(54) Customized Distribution of Advertising Impressions

(75) Inventors: Jagpreet S. Duggal, San Francisco, CA (US); Russell K. Ketchum, Newport Beach, CA (US); Davi K. Robison, New York, NY (US); Robert D. Gardner, Irvine, CA (US); Alexandr Y. Smolyanov, Rancho Santa Margarita, CA (US)

Correspondence Address: FISH & RICHARDSON P.C., PO BOX 1022, MINNEAPOLIS, MN, 55440-1022, US

(73) Assignee: Google Inc.

(21) Appl. No.: 11/832,593

(22) Filed: Aug. 1, 2007

(51) Int. Cl. G06Q 30/00

(52) U.S. Cl. 705/14

(57) ABSTRACT

Among other things, a computer-implemented method for customizing the distribution of advertising impressions includes generating a target number of advertising impressions for one or more advertising categories based, at least in part, on a non-uniform percentage distribution of advertising impressions for an advertising campaign, the percentage distribution corresponding to the one or more advertising categories. A determination is made on whether enough advertising inventory is available to fulfill the target number of advertising impressions. When a shortage of available inventory is detected in the one or more advertising categories, an actual number of advertising impressions for the one or more advertising categories is generated.

### TECHNICAL FIELD

The subject matter described in this specification relates to customizing the distribution of advertising impressions.

### BACKGROUND

Advertisements can be included in various forms of broadcast media. For example, radio can be a powerful broadcast medium for advertisers to achieve their goals for a given advertising campaign. Additionally, radio advertising can increase online brand awareness and be a cost effective way to reach targeted audience. For example, an advertiser can target consumers with a specific lifestyle and demographics by selecting the station types, locations, and dayparts. Advertisers can book advertising spots with multiple broadcasters through an advertising intermediary. Advertisers can specify criteria by which the intermediary selects spots for their ad campaigns.

### SUMMARY

This specification describes an ad buying system that allows an advertiser to specify a customized distribution of non-uniform weighting factors for ad impressions across different geographical markets, days of a week, and/or dayparts.

In one aspect, a computer-implemented method for customizing the distribution of advertising impressions includes generating a target number of advertising impressions for one or more advertising categories based, at least in part, on a non-uniform percentage distribution of advertising impressions for an advertising campaign, the percentage distribution corresponding to the one or more advertising categories. A determination is made on whether enough advertising inventory is available to fulfill the target number of advertising impressions. When a shortage of available inventory is detected in the one or more advertising categories, an actual number of advertising impressions for the one or more advertising categories is generated.

Implementations can optionally include one or more of the following features. The non-uniform percentage distribution of advertising impressions is obtained from an advertiser. Generating the actual number of advertising impressions for the one or more advertising categories includes modifying the non-uniform percentage distribution based on an overflow parameter. The overflow parameter can also be obtained from an advertiser. Also, the target number can be compared against the actual number of advertising impressions. Based on the comparison, at least one compensation scheme can be applied to minimize a difference between the target number and the actual number. Applying the at least one compensation scheme includes at least one of setting the target number of impressions as a maximum number of target impressions; modifying the non-uniform percentage distribution; and reducing a maximum number of target impressions. Obtaining a non-uniform percentage distribution corresponding to one or more advertising categories can include enabling the advertiser to select the one or more advertising categories from a group that includes geographical markets, dayparts, and days of a week; and enabling the advertiser to select the non-uniform percentage distribution that corresponds to the selected one or more advertising categories. Enabling the advertiser to select the one or more advertising categories from the group that includes geographical markets, station tiers, stations formats, listener demographics, dayparts, and days of a week can include enabling the advertiser to select one geographical market and two or more dayparts for the selected geographical market. Alternatively, the advertiser can be enabled to select two or more geographical markets and one or more dayparts for each selected geographical market. In addition, the advertiser can be enabled to select one or more days of a week for each selected geographical market. In addition, an initial number of impressions for each advertising category can be reserved, with the initial number being less than the target number. Further, the initial number can be iteratively increased until the shortage in inventory is detected or the target number reached.

In another aspect, a system of customizing distribution of advertising impressions includes a user input device. The system also includes one or more computer systems coupled to the user input device. The one or more computer systems includes a display and a processor designed to provide a graphical user interface that includes an input selector designed to obtain a user selection of one or more advertising categories and a non-uniform percentage distribution of advertising impressions for an advertising campaign. The obtained percentage distribution corresponds to the selected one or more advertising categories. The graphical user interface also includes a display region designed to display a target number of advertising impressions generated for the one or more advertising categories based, at least in part, on the obtained percentage. The one or more computers are designed to determine whether enough advertising inventory is available to fulfill the target number of advertising impressions. When a shortage of available inventory is detected in the one or more advertising categories, an actual number of advertising impressions for the one or more advertising categories is generated.

Implementations can optionally include one or more of the following features. The input selector of the graphical user interface can be designed to obtain a overflow parameter that modifies the non-uniform percentage distribution when activated. The one or more computer systems can be designed to detect a shortage of available advertising inventory in the one or more advertising categories. The one or more computer systems can also be designed to activate the obtained overflow parameter to modify the non-uniform percentage distribution based on the detected shortage. In addition, the one or more computer systems can be designed to generate the actual number of advertising impressions based on the modified non-uniform percentage distribution. The one or more computer systems can be designed to compare the target number against the actual number of advertising impressions; and based on the comparison, apply at least one compensation scheme to minimize a difference between the target number and the actual number. The one or more computer systems can further be designed to apply the at least one compensation scheme by performing at least one of setting the target number of impressions as a maximum number of target impressions; modifying the non-uniform percentage distribution; and reducing a maximum number of target impressions. The input selector of the graphical user interface can be designed to receive advertiser selection of the one or more advertising categories from a group that includes geographical markets, station tiers, station formats, listener demographics, dayparts, and days of a week. The input selector can also be designed to receive advertiser selection of the non-uniform percentage distribution that corresponds to the selected one or more advertising categories. The input selector of the graphical user interface can also be designed to receive advertiser selection of one geographical market and two or more dayparts for the selected geographical market; or receive advertiser selection of two or more geographical markets and one or more dayparts for each selected geographical market. Further, the input selector of the graphical user interface can be designed to receive advertiser selection of one or more days of a week for each selected geographical market. In addition, the one or more computers can be configured to reserve an initial number of impressions for each advertising category, with the initial number being less than the target number. Further, the initial number can be iteratively increased until the shortage in inventory is detected or the target number reached.

In another aspect, customizing distribution of advertising impressions can be implemented using a computer program product, embodied on a computer-readable medium, designed to cause a data processing apparatus to perform various operations including generating a target number of advertising impressions for one or more advertising categories based, at least in part, on a non-uniform percentage distribution of advertising impressions for an advertising campaign. The percentage distribution corresponds to the one or more advertising categories. The computer program product is designed to cause the data processing apparatus to determine whether enough advertising inventory is available to fulfill the target number of advertising impressions. When a shortage of available inventory is detected in the one or more advertising categories, the computer program product is designed to cause the data processing device to generate an actual number of advertising impressions for the one or more advertising categories.

Implementations can optionally include one or more of the following features. The computer program product can also be designed to cause the data processing apparatus to generate the actual number of advertising impressions for the one or more advertising categories by modifying the non-uniform percentage distribution based on an overflow parameter. The computer program product can be further designed to cause the data processing apparatus to obtain the non-uniform percentage distribution of advertising impressions from an advertiser. Also, the computer program product can be designed to cause the data processing apparatus to compare the target number against the actual number of advertising impressions, and based on the comparison, apply at least one compensation scheme to minimize a difference between the target number and the actual number. The computer program product can be designed to cause the data processing apparatus to apply the at least one compensation scheme by performing at least one of setting the target number of impressions as a maximum number of target impressions; modifying the non-uniform percentage distribution; and reducing a maximum number of target impressions. The computer program product can be designed to cause the data processing apparatus to obtain the non-uniform percentage distribution of advertising impressions from the advertiser by enabling the advertiser to select the one or more advertising categories from a group that includes geographical markets, station tiers, station formats, listener demographics, dayparts, and days of a week. Alternatively, the advertiser can be enabled to select the non-uniform percentage distribution that corresponds to the selected one or more advertising categories. Further, the computer program product can be designed to cause the data processing apparatus to enable the advertiser to select one geographical market and two or more dayparts for the selected geographical market. Alternatively, the computer program product can be designed to cause to data processing apparatus to enable the advertiser to select two or more geographical markets and one or more dayparts for each selected geographical market. In addition, the computer program product can be designed to cause the data processing apparatus to enable the advertiser to select one or more days of a week for each selected geographical market. In addition, an initial number of impressions for each advertising category can be reserved, with the initial number being less than the target number. Further, the initial number can be iteratively increased until the shortage in inventory is detected or the target number reached.

In another aspect, data associated with an advertising campaign is obtained. The obtained data includes at least a budget and a non-uniform percentage distribution of advertising impressions corresponding to one or more advertising categories. An initial number of advertising impressions is reserved for the one or more advertising categories. The initial number is incrementally increased to obtain the non-uniform percentage distribution until the budget is reached or a shortage of inventory is detected.

Implementations can optionally include one or more of the following features. An overflow parameter can be applied when the shortage of inventory is detected.

In another aspect, a system of customizing distribution of advertising impressions includes a display means for presenting a graphical user interface designed to obtain a user selection of one or more advertising categories. The graphical user interface is also designed to obtain a non-uniform percentage distribution of advertising impressions for each selected advertising categories in an advertising campaign. The further the graphical user interface is designed to display a target number of advertising impressions generated for the one or more advertising categories based, at least in part, on the specified percentage. The system also includes one or more computing means for determining whether enough advertising inventory is available to fulfill the target number of advertising impressions. The computing means is also designed to when a shortage of available inventory is detected in the one or more advertising categories, generating an actual number of advertising impressions for the one or more advertising categories.

The subject matter described in this specification potentially can provide various advantages. For example, because the advertisers are not limited to uniform distribution of advertising impressions, each advertiser is able to design an ad campaign that is tailored to its needs. Such customized distribution of advertising impressions enables the advertiser to have a more complete control over the ad campaign creation. Also, since the advertiser can visual potential shortage of inventories in one or more of the geographical markets, days of a week, and/or dayparts, the advertiser is able to modify the ad campaign dynamically.

The subject matter described in this specification can be implemented as a method or as a system or using computer program products, tangibly embodied in information carriers, such as a CD-ROM, a DVD-ROM, a HD-DVD-ROM, a Blue-Ray drive, a semiconductor memory, and a hard disk. Such computer program products may cause a data processing apparatus to conduct one or more operations described in this specification.

In addition, the subject matter described in this specification can also be implemented as a system including a processor and a memory coupled to the processor. The memory may encode one or more programs that cause the processor to perform one or more of the method acts described in this specification. Further the subject matter described in this specification can be implemented using various data processing machines.

### BRIEF DESCRIPTION OF DRAWINGS

These and other aspects will now be described in detail with reference to the following drawings.

FIG. 1 is a block diagram of an ad campaign.

FIG. 2a is a block diagram illustrating a system for allocating advertising spots.

FIG. 2b is a block diagram illustrating a system for receiving inputs from an advertiser.

FIG. 2c is a block diagram of a system showing advertiser selectable weighting factors for advertiser selected geographical markets and dayparts.

FIG. 3 is a process flow diagram of a process for enabling advertisers to select non-uniform weighing factors.

FIGS. 4a, 4b, 4c, 4d and 4e illustrate a process flow diagram of a process for interpreting obtained information to generate an ad campaign.

FIG. 5 illustrates an exemplary Graphical User Interface (GUI) for enabling an advertiser to select and apply one or more of enhancement schemes.

FIG. 6 is a process flow diagram illustrating another process of providing non-uniform distribution of advertising impressions.

FIG. 7 is a block diagram of an exemplary computing device and system that can be used, e.g., to implement non-uniform distribution of impressions.

Like reference symbols in the various drawings indicate like elements.

### DETAILED DESCRIPTION

The following describes techniques for enabling a customized distribution of non-uniform weighting factors for ad impressions across different geographical markets, days of a week, and/or dayparts.

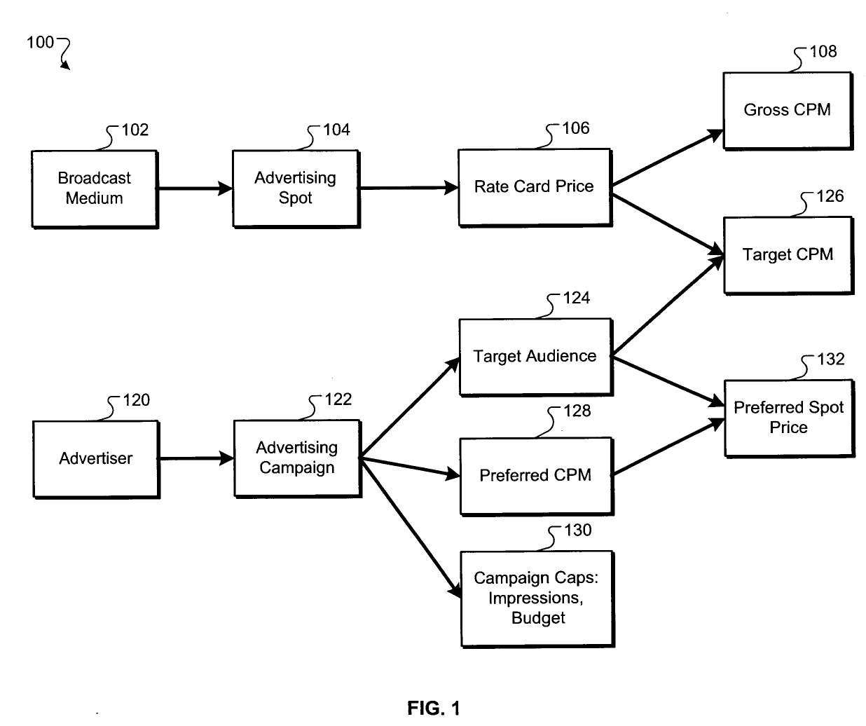

FIG.1 is a conceptual diagram of an ad campaign 100 showing relationships between ad concepts. The diagram shows a broadcast medium 102, which can, e.g., include radio, television, and Internet broadcast media. A broadcaster (not shown) can deliver broadcast content to the audience via broadcast medium 102. Additionally, various advertising spots, such as advertising spot 104, can be included as part of the broadcast content. The advertising spots are time slots when ads can play during a broadcast. For example, advertising spot 104 can be a 30-second time slot of the broadcast content.

An advertising intermediary (e.g., Google® Adwords for Audio) can have a price rate (i.e., spot price or rate card price 106) associated with advertising spot 104. The rate card price 106 can be a function of the number of estimated audience, which can vary based on the type of broadcaster, broadcasting market (e.g., Los Angeles vs. San Diego), and broadcasting daypart (individual time segments, e.g., morning commute vs. evening commute). For example, in radio advertising a commonly used measure of estimated listeners can be a metric called average quarter hour (AQH) persons. The gross AQH can be defined as the average number of persons (ages 12 and above) listening to a broadcast for at least five consecutive minutes of a given 15-minute period.

This information on gross AQH can be provided by third-party ratings companies, such as Arbitron®. Thus, using the rate card price and the number of estimated audience for that advertising spot, a cost per mille (CPM) metric, or cost per thousand impressions, can be calculated. An impression can be defined as when an ad is played (either audibly or visually) so that an audience can perceive the ad. For example, given rate card price 106 and a gross AQH number for the spot, a gross CPM 108 can be determined using Equation (1).

gross CPM=(rate card price/gross AQH)*1000 (1)

The conceptual diagram of FIG. 1 also shows an advertiser 120 who is interested in increasing its revenue by launching an advertising campaign 122. The advertiser 120 can define a marketing objective for the advertising campaign 122. For example, the objectives can be to increase awareness of the advertiser or the advertiser's product. Additionally, the marketing objectives can be to drive sales for a specific promotion, holiday, or event. Thus, the advertiser 120 can specify various criteria for the advertising campaign 122 in order to achieve the marketing objective.

As an example, the advertiser 120 can specify a target audience 124 for the advertising campaign 122. For example, suppose that the advertising campaign 122 is a radio advertising campaign; specifying the target audience 124 can include targeting by location, gender, age, station the audience listens to, and drive time/time of day the audience might be listening. Additionally, based on the demographic information of the target audience 124 for the advertising campaign 122, a target AQH can be calculated from the gross AQH number described above.

For instance, suppose that the gross AQH for an advertising spot is 10,000 persons, which means that on average 10,000 listeners (ages 12 and above) listen to the broadcast for at least five consecutive minutes in a 15-minute time period. Further, suppose that the target audience is only male listeners who are between the ages of 24 and 40. Based on this information and the gross AQH number, a target AQH number, can be, e.g., 2000 listeners that fit the demographic profile. Additionally, a spot efficiency number for the targeted demographic profile can be determined as shown in Equation (2)

efficiency=target AQH/gross AQH (2)

Given rate card price 106 and a target AQH number for the spot, a target CPM 126 for advertising spot 104 can be determined using Equation (3).

target CPM=(rate card price/target AQH)*1000 (3)

Since the target AQH is a percentage (depending on the targeted demographic profile) of the gross AQH, the target CPM is always greater than or equal to the gross CPM for an advertising spot. For example, if the rate card price for an advertising spot is $10 and the gross AQH is 10,000 listeners, while the target AQH is 2000 listeners, then the gross CPM is $1 and the target CPM is $5 for the advertising spot.

In addition to the target audience 124, the advertiser 120 can also specify a preferred CPM 128 for the advertising spots allocated in the ad campaign 122. The preferred CPM 128 is the amount the advertiser 120 is willing to pay per thousand impressions in the ad campaign 122. For example, the advertiser 120 may specify that the preferred CPM 128 be $4 per advertising spot. The advertiser 120 can further specify a cap 130 for the ad campaign 122, which can include, e.g., number of impressions, daily budget, weekly budget, and total budget. Furthermore, a preferred spot price 132, which is the amount that the advertiser is willing to pay per advertising spot, can be calculated based on the target audience information 124 and the preferred CPM 128.

For example, if the preferred CPM 128 is $4 and the target AQH derived from the target audience information 124 is 2000 listeners, then the preferred spot price 132 is $8 as determined using Equation (4).

preferred spot price=(preferred CPM*target AQH)/1000 (4)

The preferred spot price 132 can be used by the ad IMS to allocate advertising spots for the advertising campaign 122. In this manner, when allocating a new advertising spot to the advertising campaign 122, the ad IMS can use a metric (e.g., spot value, which is described in detail below) to give the advertiser 120 advertising spots so that the rate card price most closely matches with the preferred spot price. As an example, the spot value can be defined as the difference between the preferred spot price 132 and the rate card price 106 as shown in Equation (5).

spot value=preferred spot price−rate card price (5)

Thus, the spot value can be a real number (negative to positive number) that measures the deviation between the preferred spot price 132 and the rate card price 106. Alternatively, spot value can be determined based on the target AQH and CPM as shown in Equation (6).

spot value=(target AQH/1000)*(preferred CPM−target CPM). (6)

For example, suppose that an advertiser specifies a preferred CPM of $4 for the ad campaign. Those advertising spots with a target CPM greater than the preferred CPM will result in negative spot value. On the other hand, those advertising spots with a target CPM less than the preferred CPM will result in positive spot value. Moreover, when the target CPM equals the preferred CPM, the spot value for the advertising spot will be zero.

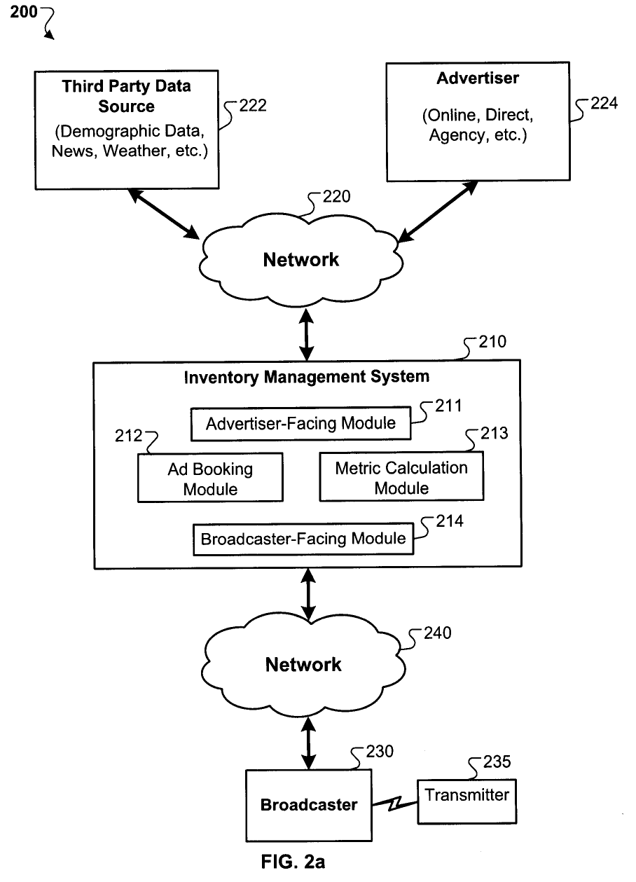

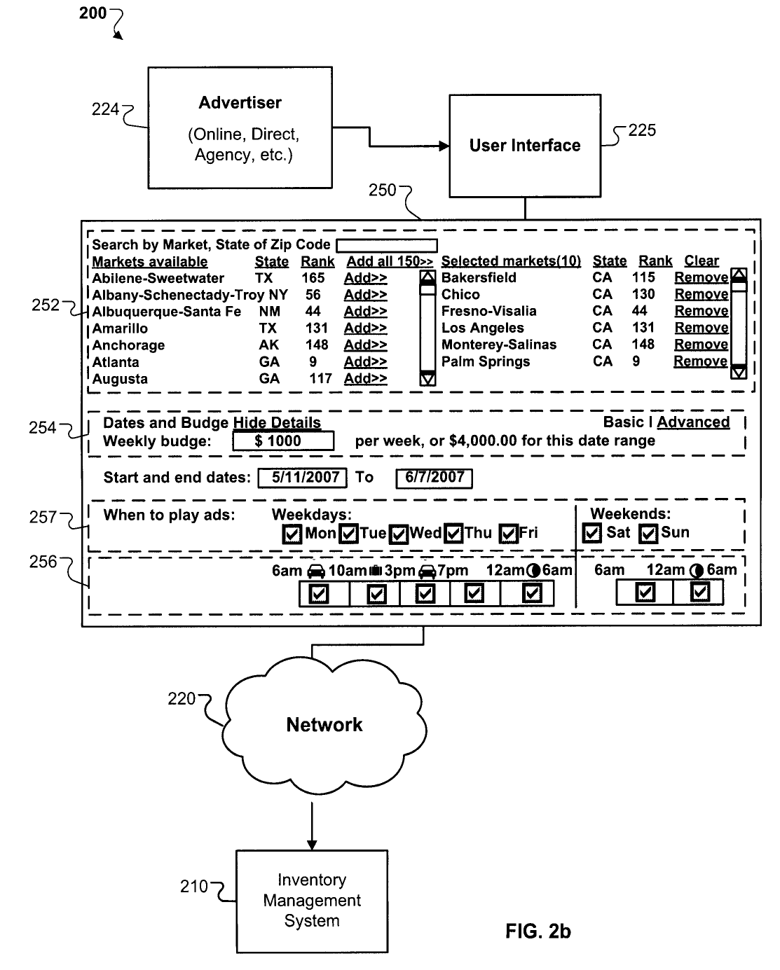

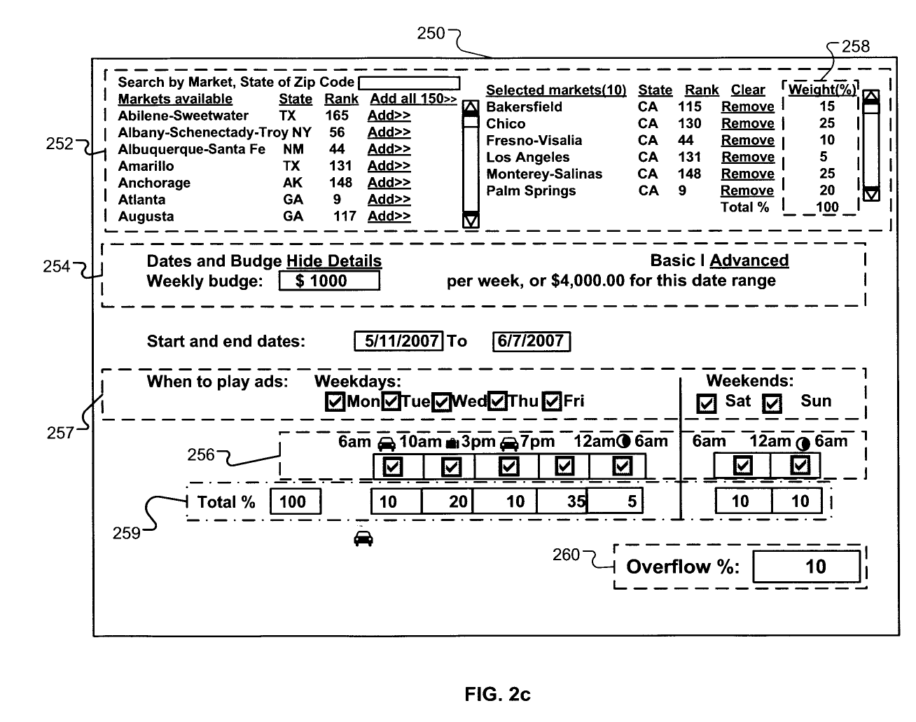

FIG. 2a is a schematic diagram of a system 200 for allocating advertising spots. The methods, processes, engines, apparatus, computer program products, systems and the like discussed below can be applicable to audio advertising environment and other communication environments including broadcast television, cable television, satellite television, Internet communication systems (including Internet radio and Internet TV), and other communication environments.

Ads can be inventoried and categorized for system 200 in several ways, e.g., by keyword, price, vendor, last played, and the like. In some implementations, the broadcasters can use the ad inventory information and other data to schedule current ads, and reschedule new ads that may be more suitable (e.g., suitable in terms of content, price, or other criteria) in a particular time slot. For example, a broadcaster can sell a last-minute ad at a higher price (e.g., higher CPM) than other previously received ads.

As shown in FIG. 2a, system 200 includes an ad inventory management system (IMS) 210, which can include an advertiser-facing module 211, an ad booking module 212, a metric calculation module 213, and a broadcaster-facing module 214. The advertiser-facing module 211 can interface with and communicatively couple third-party data source 222 and advertiser 224 via a network 220. In this example, the network 220 is the Internet. In other implementations, the network 220 can include any network, such as a local area network, metropolitan area network, wide area network, a wired or wireless network, a private network, or a virtual private network.

The ad booking module 212 can be used by the IMS to, e.g., book advertising spots for an ad campaign. The metric calculation module 213 can be used by the IMS to, e.g., calculate the target AQH and the spot value for an advertising spot. The broadcaster-facing module 214 can interface via network 240 with broadcaster 230, which can be, e.g., a radio station. In one implementation, network 240 can be a similar network as network 220. The broadcaster 230 can deliver broadcast content to the audience via transmitter 235.

The third-party data source 222 can include any database, data mart, or other data source that provides data of interest to the advertiser 224 relevant to the scheduling of advertisements. For example, third-party data can be Arbitron® ratings and demographic breakdowns for each station in a broadcast network. Further, such third-party data can be of use to an advertiser 224 in deciding what amount it would be willing to pay to run an ad campaign on a given station. In addition, third-party data can be the weather forecast, current weather conditions, or news events such as stock prices, sports scores, data from a syndicated data feed such as an RSS feed, or any other data relevant to a advertiser's desire to play an ad.

The advertiser 224 can include, e.g., online advertiser, direct advertiser, and advertising agency. The advertiser 224 can access the IMS 210 via a connection to the Internet 220. The connection can include, e.g., a TCP/IP protocol using a conventional dial-up connection over a modem, or a dedicated connection that provides constant access (e.g., a cable modem or a DSL connection). The IMS 210 can have a unique HTTP address, a unique FTP address, or any other addressing scheme that allows advertiser 224 to identify IMS 210. In one implementation, advertiser 224 can have an account with the IMS 210 and be charged a fee for use of the IMS 210. In another implementation, advertiser 224 can access the IMS 210 free of charge.

When creating an ad campaign, the advertiser 224 can choose the degree of customization desired. In general, by providing a loosely constrained set of inputs (e.g., budget, listing of desired geographical markets, listing of desired dayparts, listing of desired days of a week, listing of desired station formats, demographics, listing of desired station tiers, etc.), the advertiser 224 can allow the IMS 210 to determine and calculate a distribution among the geographical markets, dayparts, days of a week, station formats, station tiers, etc. Examples of station formats includes adult contemporary, Easy Listening, Religious, News, Rock, Urban, Oldies, Spanish, Country, Pop, Sports, etc. Also, desired demographic includes specifying by gender and/or age range. In the simplest option, advertiser 224 can provide inputs that enables the IMS to generate an even distribution among the designated geographical markets, days of a week, station formats, station tiers, and dayparts within the budget constraint. Alternatively, the advertiser 224 can opt to allow the IMS to distribute impressions proportionately based on market size (e.g., more impressions to larger markets). In an advanced option, the advertiser 224 can choose to provide inputs that enables the advertiser itself to customize as much of the distribution (e.g., among geographical markets and/or dayparts, etc.) as desired.

FIG. 2b is a block diagram of the system 200 that illustrates receiving inputs from an advertiser. The advertiser 224 interfaces with a user input device 225 (e.g., a touch screen, a combination of a display and a user input device such as a mouse, etc.) to provide input 250 related to creating an ad campaign. The input 250 provided can include among others, selection of specific geographical markets 252, a budget 254, days of a week 257, and dayparts 256. The input 250 provided by the advertiser 224 through the user input device 225 is received by the IMS 210 over a network 220.

The advertiser 224 can specify a non-uniform distribution among the selected geographical markets 252, days of a week 257 and/or dayparts 256. For example, the advertiser 224 can specify a percent weight to each geographical market 252. In addition, one or more days of a week 257 can be specified for each selected geographical market 252. Further, one or more dayparts 256 can be specified for each day selected. In some implementations, broadcast stations can be selected based on the designated format or tier. For example, a radio station maybe designated as tier one, tier two, tier three, etc. based on the number of listeners captured by that station. The top tier (e.g., tier one) stations are the highest rated (most listeners) stations, and the bottom tier (e.g., tier three or lower) stations are the lowest rated (fewer listeners) stations.

FIG. 2c is a block diagram of the system 200 showing advertiser 224 selectable weighting factors 258 and 259 for the selected geographical markets and dayparts. In the example shown in FIG. 2c, each of the six selected geographical markets (e.g., Bakersfield, Calif.; Chico, Calif.; Fresno-Visalia, Calif.; Los Angeles, Calif.; Monterey-Salinas, Calif. and Palm Springs, Calif.) are assigned individual weight factors 258. In addition, the seven selected dayparts are also assigned individual weighing factors 529. Further, for each selected market 252, the advertiser 224 can select the desired dayparts 258 and specify weight factor 259 for each selected day parts. When the advertiser 224 does not desire to specify customized weighing factors, the weight factors 258 and 259 can be left blank and a uniform distribution is automatically calculated for the selected geographical markets 252 and/or dayparts 256. The weighing factors are selected as direct percentages of total impressions requested (e.g., 10% for Market A, 40% for Market B and 50% for Market C.)

In some implementations, weighing factors are selected using indirect percentages of total impressions based on other factors such as ratings of each market and/or customized budget allocation by market, daypart, days of the week, station format, demographics, station tiers, etc. For example, assume that the weighing factors are defined based on the budget allocated to Markets A, B, and C. Instead of inputting 10%, 20%, etc., the budget % or money values are inputted. Assigning $2,000 to Market A, $1,000 to Market B, and $5,000 Market C will necessarily result in various percentage of overall target impressions being applied for each market.

In some implementations, a correction factor, such as overflow 260 can be used in an attempt the obtain the requested non-uniform distribution weighing factors. Overflow 260 can be used as a mechanism to yield an appropriate distribution of impressions by daypart 256 (and/or geographical market 252) during ad campaign forecasting process. Once the ad campaign is booked, the overflow 260 function is not observed by the system 200.

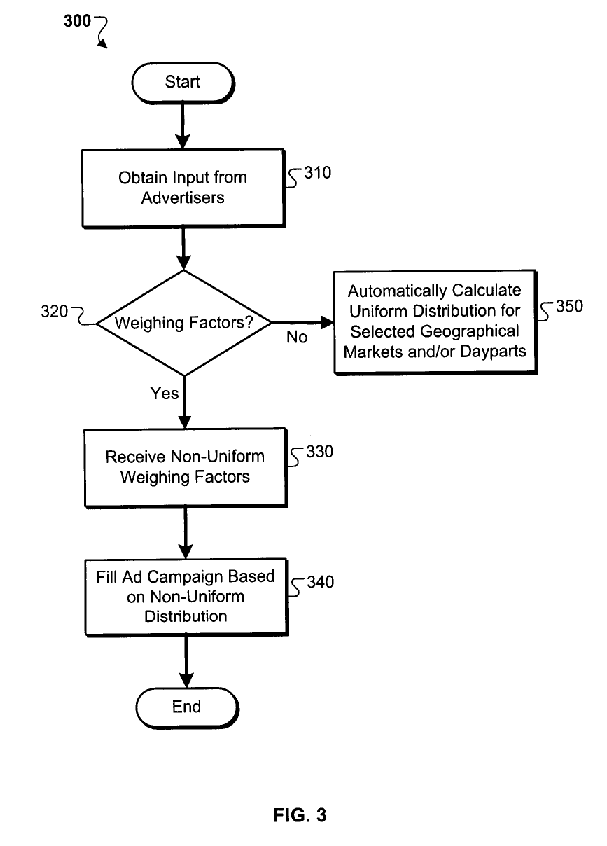

FIG. 3 is a process flow diagram of a process 300 of enabling advertisers to select non-uniform weighing factors. At 310, input regarding a desired ad campaign is received from the advertiser 224. The received input can include budget consideration, demo CPM, geographical market selections and daypart selections for each geographical market selected. At 320, a determination is made on whether non-uniform weighing factors are to be selected by the advertiser. This can simply involve detecting weighing factors entered by the advertiser 224. Alternatively, an affirmative selection option can be provided (e.g., “Do you want to enter weighing factors?”) to the advertiser 224. When determined that weighing factors are to be entered by the advertiser 224, advertiser selected weighing factors are received at 330. Based on the received non-uniform weighing factors, ad campaign is filled. However, when determined that weighing factors are not entered (e.g., left blank) by the advertiser 224, the ad campaign is filled using a uniform distribution among the selected geographical markets and/or dayparts.

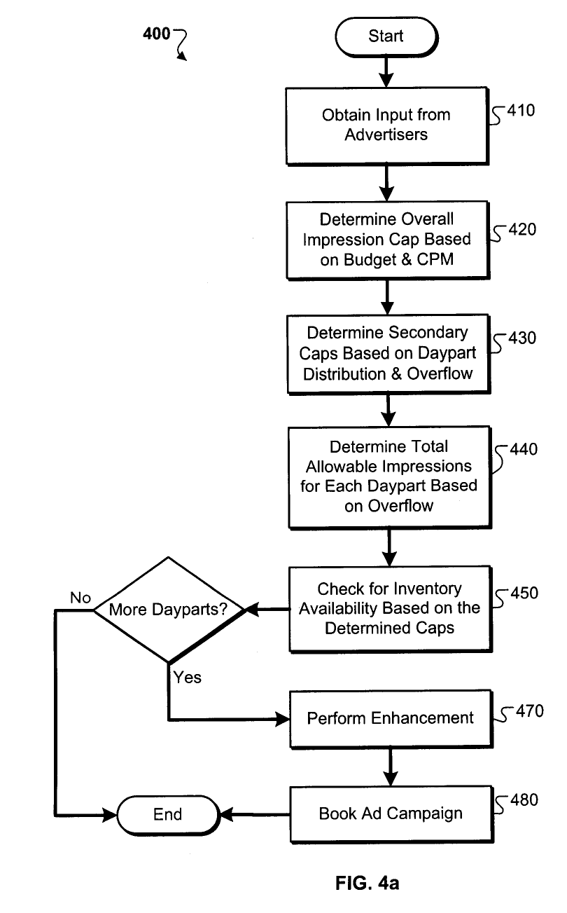

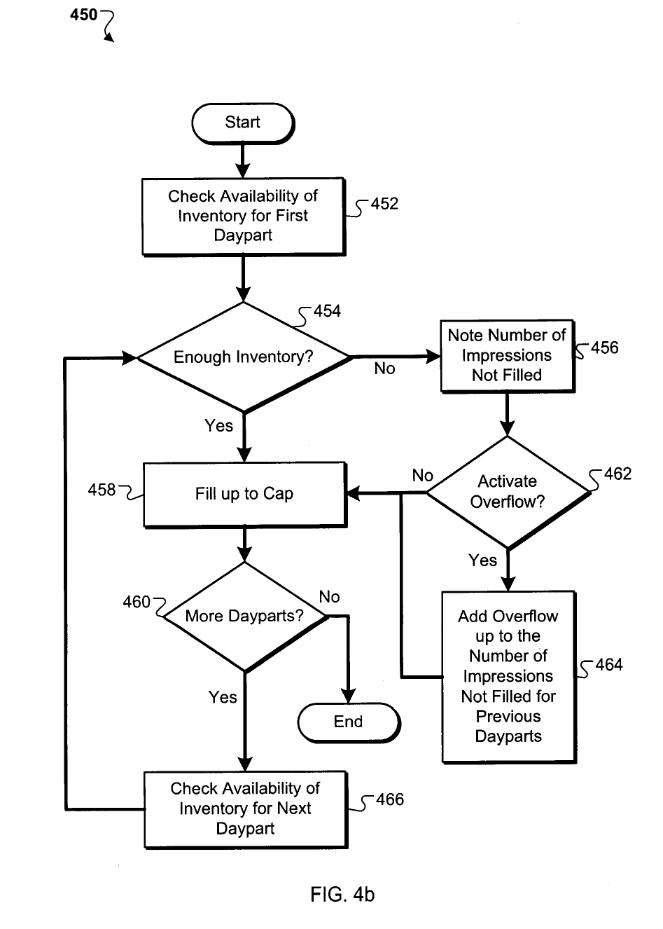

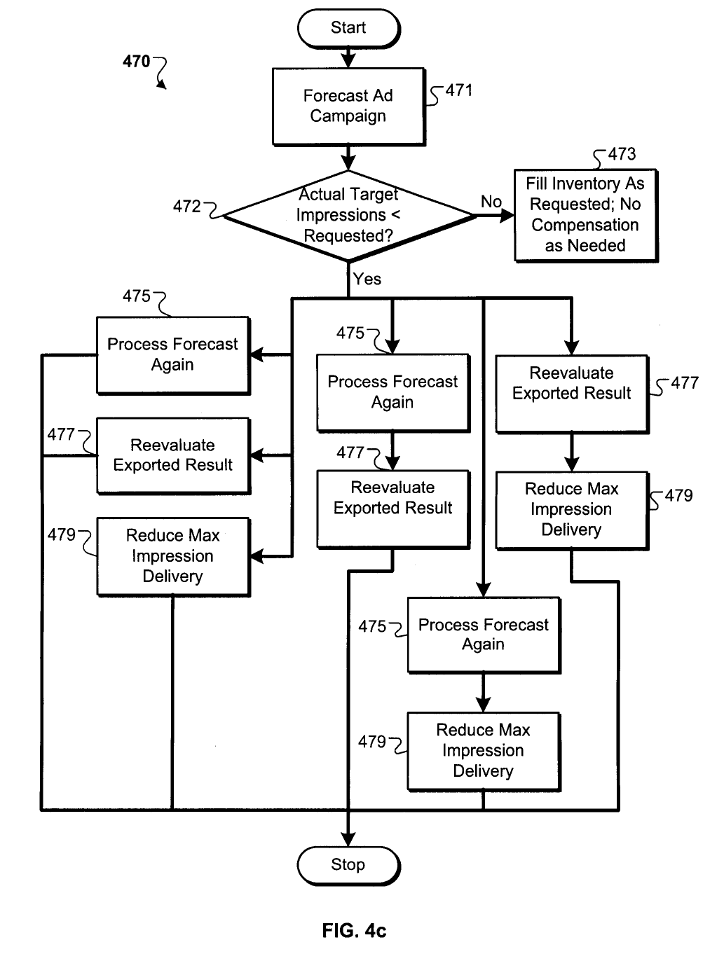

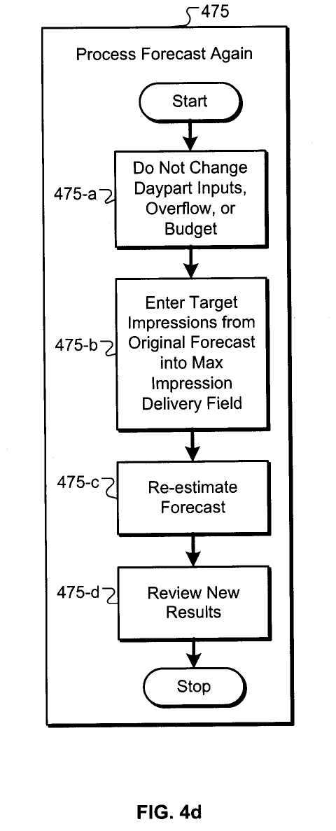

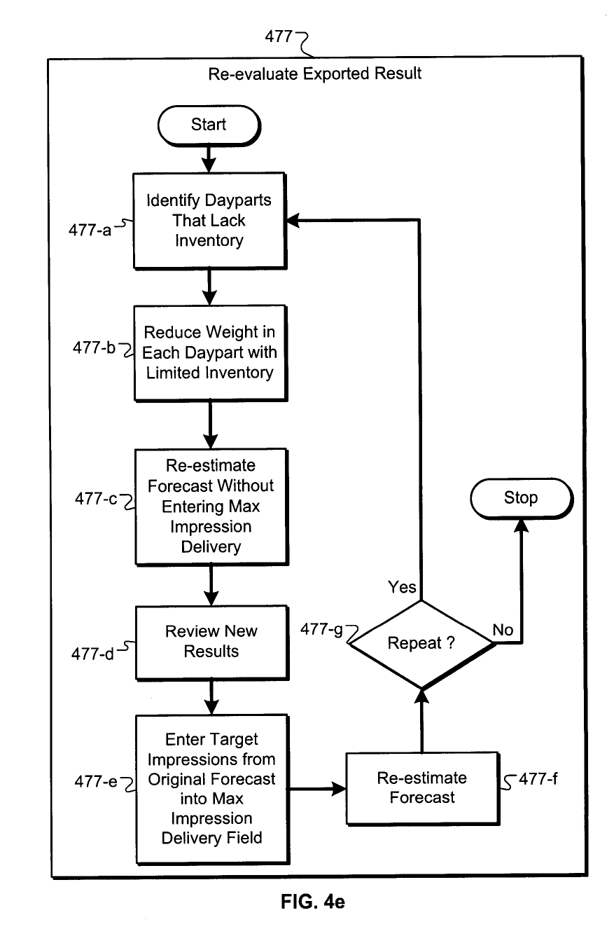

FIGS. 4a, 4b, 4c, 4d and 4e describe a process flow diagram of a process 400 of interpreting the provided input to generate an ad campaign. While the following process 400 is described with respect to daypart distribution, the process 400 is equally applicable to geographical market distribution, station tier distribution, and days of a week distribution. Based on the input received (410) from the advertiser 224, the inventory management system on the backend of the system 200 can generated an ad campaign tailored to the needs of the advertiser. For example, assume that the advertiser provides the following information (see Table 1) during the ad forecasting process:

TABLE 1
Ad Input

| | |
|---|---|
| Budget: | $10,000 |
| Demo CPM: | $5.00 |
| Daypart Allocation: | |
| AM Drive (MF6a10a): | 50% |
| Afternoon (MF10a3p): | 10% |
| PM Drive (MF3p7p): | 40% |
| Daypart Overflow: | 10% |

The system 200 interprets the above received input and determines appropriate inventory capping. The overall impression cap desired by the advertiser is determined (420) based on the received inputs. In the scenario above, a budget of $10,000 and a $5.00 CPM results in 2 million target impressions needed to meet the budget goal. The total impression cap is determined based on Equation (7).

(Budget×1000)/CPM=Total Impression Cap (7)

Once the system 200 determines the total impression cap, secondary caps are determined (430) based on the requested daypart distribution and overflow parameters. Input from the scenario described in Table 1 is analyzed by the system 200 to determine the secondary caps for the requested daypart distribution as shown in Table 2.

TABLE 2
Daypart Distribution

| Inputs | Results |
|---|---|
| 50% in AM Drive | 50% of 2 M target impressions = 1 M |
| | target impressions requested |
| | in AM Drive. |
| 10% Afternoon | 10% of 2 M target impressions = 200,000 |
| | target impressions |
| | requested in the Afternoon |
| 40% PM Drive | 40% of 2 M target impressions, or |
| | 800,000 target impressions |
| | requested in PM Drive |

The overflow parameter (selected at 10% in the above scenario) is activated only when one or more of the secondary caps (daypart based caps) cannot be met due to insufficient inventory. The overflow parameter determines the maximum deviation allowed from the determined secondary cap. The total allowable target impressions based on the allowed 10% overflow is determined (440) using Equation (8), and sample results are provided for each dayparts in Table 3.

Total Impressions After Overflow=(Secondary Cap×(1+Overflow in fraction)) (8)

TABLE 3
Total Allowable Target Impressions

| Dayparts | Results After Overflow |
|---|---|
| 50% in AM Drive | 1 Million impressions requested. |
| | 10% of 1 M is 100,000. Total |
| | allowable target impressions in AM |
| | Drive is capped at 1,100,000. |
| 10% Afternoon | 200,000 impressions requested. |
| | 10% of 200,000 is 20,000. Total |
| | allowable target impressions in the |
| | Afternoon is capped at 220,000. |
| 40% PM Drive | 800,000 impressions requested. |
| | 10% of 800,000 is 80,000. Total |
| | allowable target impressions in PM |
| | Drive is capped at 880,000. |

Based on the determined caps, the system 200 checks for inventory availability. Thus, the system 200 attempts to fill inventory according to the pre-defined caps. The available inventory is compared (450) against the capped inventory goals. Comparing (450) the available inventory for all dayparts include various operations. The available inventory is checked individually beginning with one of the daypart at 452. For example, the AM Drive is capped at 1,100,000 target impressions, including overflow. At 454, the available inventory is checked to determine whether the daypart can be filled completely. Assume that only 500,000 impressions are available for the AM Drive, then not enough inventory exists. It is noted (458) that not enough inventory exists. Also, the number of impressions not filled (in this case, 500,000) is noted. Since, not enough inventory exists, overflow is not activated (462). The system 200 holds those available 500,000 impressions, at 458. When determined that there are still more dayparts to be checked (460), the system 200 proceeds to fill the inventory for the next daypart at 466.

Continuing with the same example, the next daypart (Afternoon slot) is capped at 220,000 impressions, including the overflow. Assume that 300,000 impressions are available for the Afternoon slot. Since the available inventory for the previous daypart (AM Drive) is noted to be less than the desired cap, the system 200 activates (462) overflow. At 10% overflow, the maximum overflow is 20,000 impressions, which is less than the 500,000 impressions that were not filled in the previous dayparts (AM Drive). Thus, the system holds the entire 220,000 impressions in the Afternoon slot at 458.

When determined that more dayparts remain to be checked (460), the next daypart (PM Drive) is checked. The total impressions for PM Drive is capped at 880,000 impressions, including the overflow. Again, since the AM Drive came up short, the system 200 activates (462) overflow again. Assume 1,000,000 impressions are available for the PM Drive. The entire 880,000 impressions, including full overflow of 80,000, are filled for the PM Drive at 458. For all dayparts combined, 1,600,000 target impressions are being held for possible reservation. This is 400,00 target impressions short of the request 2 million. The actual distribution of those impressions according to the system's ability to service the caps is determined using Equation (9).

(Daypart Impressions/Total Impressions)×100=% Daypart (9)

A comparison of the requested vs. actual distribution is shown in Table 4.

TABLE 4
Actual vs. Requested Distribution

| Requested | Actual |
|---|---|
| AM Drive: 50% | AM Drive: 31.25% |
| Afternoon: 10% | Afternoon: 13.75% |
| PM Drive: 40% | PM Drive: 55% |

The overflow is applied in an attempt to maximize total target impressions. By doing so, the actual obtained weights applied for the dayparts and/or markets may differ from the requested weights. To balance the tradeoff between meeting the requested total impressions and meeting the requested weighted impressions, various enhancements can be applied (470) to the system 200. For example, at the time of forecasting, more visibility can be provided to the advertiser about specific inventory issues that may contribute to daypart imbalances. Thus, the advertiser can make informed decisions when planning schedules and have more direct influence over % distribution for each daypart when inventory is limited. These enhancements are executed by the IMS system 210 on the backend of the system 200. However, in some implementations, the enhancements are made available as user selectable options to the Advertiser 224.

FIGS. 4c, 4d and 4e are process flow diagrams that describe the various enhancements schemes available. The ad campaign is forecasted (472) in a manner described in this specification. It is noted that overflow is activated only when one or more dayparts lack inventory to meet the impression cap. Thus, forecasts can be made at maximum daypart overflow rates since overflow only magnifies a lack of inventory in the forecast which can be adjust in several ways before booking. The result of the forecast is exported to determine (474) whether any daypart yielded a smaller % or fewer target impressions than requested. Such reduced yield indicates a lack of inventory in that daypart. When sufficient inventory is detected for all dayparts, the impressions are allocated for each dayparts up to the determined caps. When a lack of inventory is detected, one or more of the following enhancement schemes can be implemented while considering various factors including the received input, flexibility of the advertiser, etc.

In a first enhancement scheme, the forecast is processed again (475). No changes (475-a) are made to the daypart inputs, overflow or requested budget. Instead, the target impressions, that IMS returned in the original forecast, are applied (475-b) as the maximum impression delivered (e.g., using an input field in the spending options section of a GUI). The forecast is re-estimated (475-c). The new results are exported to review (475-d) the new daypart distribution.

When such re-forecasting doesn't yield an appropriate result, the exported result can be reevaluated (477) depending on various factors, e.g., the advertiser's objectives and/or flexibility. When detected that the Advertiser is not firm on his requested daypart distribution and will tolerate flexibility (e.g., overflow is not “0”), the following reevaluation scheme may be implemented. Re-evaluating the result includes various operations. Dayparts that lack inventory are identified (477-a). For the identified dayparts with limited inventory, the requested weight (%) in that daypart is reduced (477-b). The forecast is re-estimated (477-c) without entering the max impression delivery. The exported new result is reviewed (477-d). The target impressions, that IMS returned, are entered (477-e) as input for the max impression delivery field and the forecast is re-estimated (477-f). The processes of manipulating daypart percentages, and exporting result are repeated as needed.

When the requested daypart distribution is firm, the max impression delivery as set in the spending options may be reduced (479). This scheme may take several iterations. With each iteration, the impressions are continuously reduce until the exported result yields the requested (or acceptable) distribution. This option may limit the ability of the system 200 to service the ad campaign buy, but may bring the distribution into line when the result arrives at a point that each daypart can fill to its cap without running out of inventory.

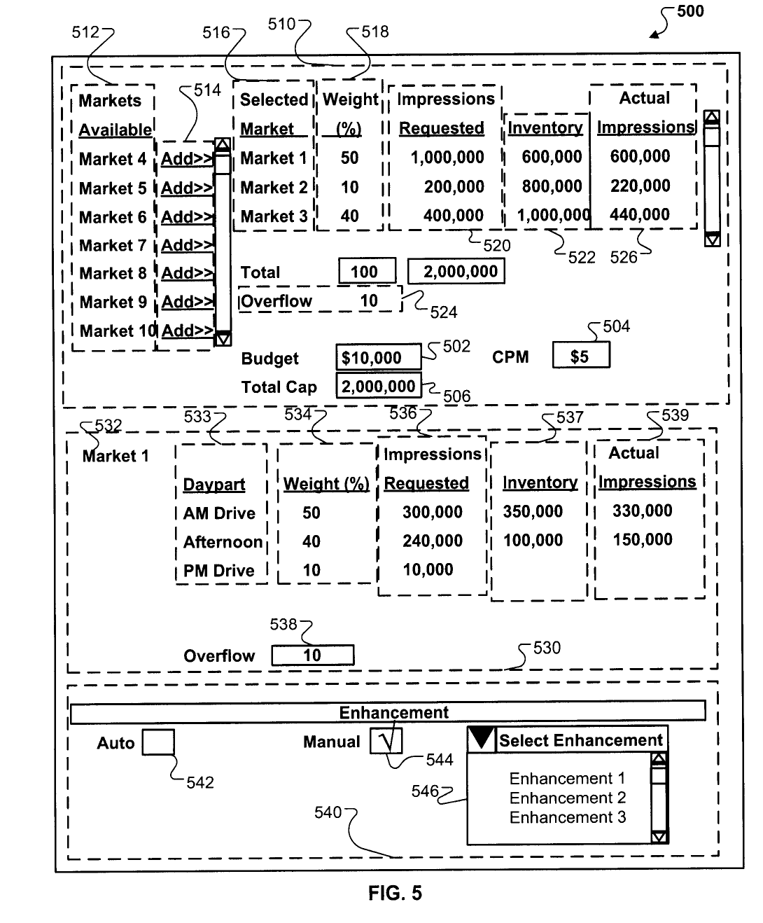

FIG. 5 illustrates an exemplary Graphical User Interface (GUI) 500 for enabling the Advertiser to select and apply one or more of the enhancement schemes. While not shown, the GUI 500 can include a days of a week input area for receiving user selection of one or more days of a week and user selected non-uniform distribution among the selected days of a week. As described with respect to FIGS. 2b and 2c, a GUI can be implemented on the front end (user side) of the system 200 to enable the advertiser 224 to control the process of forecasting ad campaigns. For example, the GUI includes a budget input area 502 and a CPM input area 504 for the advertiser 224 to enter the desired budget and CPM. Based on the entered budget and CPM, the total cap is automatically calculated according to the process described with respect to FIGS. 4a, 4b, 4c, 4d and 4e.

The GUI 500 also includes a market distribution section 510 for enabling the advertiser 224 to select one or more desired markets. A list of available markets 512 are presented to the advertiser 224 to select/add one or more markets by interfacing with a “market add” GUI element 514. The advertiser selected markets 516 are displayed to the advertiser 224 on a separate display area. For each selected market, a desired weight factor (e.g., %) 518 can be entered by the advertiser 224. For illustrative purpose, the weight factor is selected using a percentage of total impressions. However, other indirect factors, such as ratings of each market (e.g., rating points by market) and/or customized budget allocation by market, daypart, days of the week, station format, demographics, station tiers, etc. can be used to indicate a desired distribution of impressions. Based on the entered weight factor for each market, the number of requested impressions 520 are automatically calculated and displayed for each market. Also the available inventory 522 may be displayed to the advertiser to alert the advertiser to potential inventory shortage in one or more of the markets. Further, the advertiser can select an overflow parameter 524. The overflow parameter can be entered as any range of values such as a percentage, a value from a set (e.g., between 1 and 5), etc. For example, the advertiser can choose to enter “0” (e.g., no overflow), “99999999” (near infinite overflow), or something in between. The selected overflow is activated automatically when an inventory shortage is detected in one or more of the selected markets. The overflow is applied as described with respect to FIGS. 4a, 4b, 4c, 4d and 4e.

In the example shown in FIG. 5, an inventory shortage is detected for Market 1, and thus the actual impressions obtained by the system 200 is the maximum available inventory (600,000 impressions in this case). Based on the 10% overflow selected by the advertiser, extra impressions are obtained in Markets 2 and 3 (up to the overflow rate) in an attempt to compensate for the shortage in Market 1.

The GUI 500 also includes a daypart distribution section 530. For each selected market 532, the advertiser 224 can select a desired distribution. For example, from the available dayparts (e.g., AM Drive, Afternoon, PM Drive) 533, the advertiser 224 can provide a desired daypart weight % 534. The requested impressions 520 for each market are distributed based on the selected weights for each daypart. FIG. 5 shows that for Market 1, the impressions requested equals 1,000,000. However, only 600,000 impressions are available and obtained in Market 1. Thus, those 600,000 impressions are distributed and requested among the selected dayparts 533 as follows: (1) 50% or 300,000 impressions are requested in AM Drive; (2) 40% or 240,000 impressions are requested in Afternoon; and (3) 10% or 60,000 impressions are requested in PM Drive. These requested impressions 536 are automatically determined and displayed. The available inventory 537 in each daypart can also be presented to the advertiser 224 in order to alert the advertiser 224 for potential shortage in daypart inventory. If shortage is detected in any of the daypart inventories, the actual impressions 539 obtained in each daypart are determined based on the selected daypart overflow 538.

An inventory shortage is detected in the Afternoon Drive (requested 240,000 but only 150,000 in inventory). Based on the 10% overflow 538 selected by the advertiser, the impressions obtained for other dayparts are increased up to the overflow rate (assuming enough inventory). Thus, in the AM Drive, 330,000 (300,000 requested+30,000 (10%) overflow) impressions are held, and in the PM Drive, 66,000 (60,000 requested+6,000 (10%) overflow) impressions are held by the system 200.

In order to compensate for the imbalance in the market and daypart distributions, one or more enhancement schemes 540 can be implemented. The advertiser 224 can opt to select “Auto” 542 to let the system select the enhancement. Alternatively, the advertiser can opt to select “Manual” 544 to select the enhancement schemes. For example, one or more of the available enhancement schemes can be selected using a drop-down menu 546.

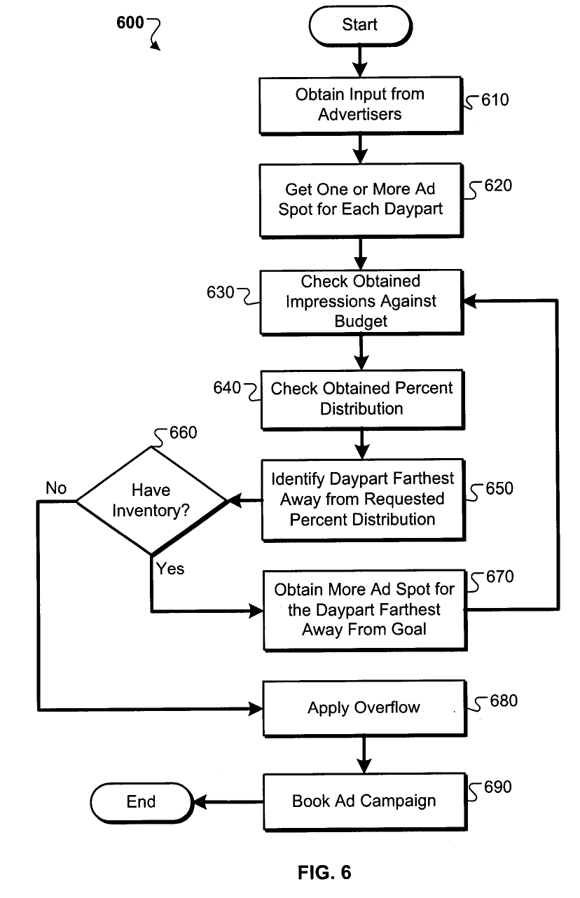

FIG. 6 is a process flow diagram that describes another process 600 of interpreting the provided input to generate an ad campaign. While the following process 600 is described with respect to daypart distribution, the process 600 is equally applicable to geographical market distribution, station tier distribution, days of a week distribution, or any other ad parameters. Based on the input received (610) from the advertiser 224, the inventory management system on the backend of the system 200 can generated an ad campaign tailored to the needs of the advertiser. For the example, assume that the advertiser provides the following information (see Table 1) during the ad forecasting process:

TABLE 1
Ad Input

| | |
|---|---|
| Budget: | $10,000 |
| Daypart Allocation: | |
| AM Drive (MF6a10a): | 50% |
| Afternoon (MF10a3p): | 10% |
| PM Drive (MF3p7p): | 40% |
| Daypart Overflow: | 10% |

This is the same scenario described with respect to FIGS. 4a, 4b, 4c, 4d and 4e. However, unlike process 400, the system 200 does not determine the overall impression cap or the secondary impression caps initially.

Instead of calculating the impressions caps for each daypart and attempting to fill each daypart up to the secondary cap, repeated distributions are made to all three dayparts. Each distribution is made with a small number of impressions (i.e., not attempting to fill up to a secondary cap). With each round of distribution, the requested percentage distribution is targeted for a single daypart. This way, all three dayparts are slowly filled with impressions until one of the dayparts runs out of inventory. At that point, the requested overflow rate is applied to the remaining dayparts to obtain a last round of distribution. Since each ad spot may have a different CPM, the cost of impressions obtained is calculated and checked against the requested budget at each distribution round.

A first round of distribution is implemented by obtaining (620) one or more ad spots for each daypart. The number of impressions returned in each obtained spot may vary by dayparts. Also, the CPM for each ad spot may vary. The cost of obtained impressions in this first round of distribution is determined and compared (630) against the set budget. Assume that the first round of distribution results in 100,000 impressions for AM Drive, 100,000 impressions for Afternoon, and 200,000 impressions for PM Drive. The obtained distribution is checked (640) and found to be 25% for AM Drive, 25% for Afternoon, and 50% for PM Drive. However, the advertiser 224 requested 50% for AM Drive, 10% for Afternoon and 40% for PM Drive. The daypart that is farthest away from the requested percent distribution is identified (650). In this instance, AM Drive is farthest away. The inventory is checked (660) for the identified daypart (AM Drive in this example), and if enough inventory exists, additional ad spots are obtained (670) for the AM Drive to achieve a percentage that is closer to the requested 50%. Assume that 500,000 impressions are available for the AM Drive.

In the next (second) distribution, impressions (by getting one or more ad spots) are obtained only for the daypart that is farthest away (AM Drive only in this example). After the second distribution, the obtained cost of impressions are determined and checked (630) against the budget. Also, the obtained percentage distribution is re-evaluated (640). Assume that 200,000 additional impression are obtained for the AM Drive to bring up the total to 300,000 impressions. For the Afternoon slot, 100,000 impressions remain from the first distribution, and 200,000 impressions remain for the PM Drive. The distribution after the second distribution is 50% for AM Drive, ˜16.66% for Afternoon, and ˜33.33% for PM Drive. At this point, the PM Drive is identified (650) as being farthest away from the requested percentage (40%). The inventory for the PM Drive is checked (660), and if enough inventory exists, additional ad spots are obtained (670) to bring the percentage distribution for the PM Drive closer to the requested distribution (40%). Assume that 1,000,000 impressions are available for the PM Drive.

The iterative process 600 continues until a lack of inventory is detected in one of the dayparts and/or the budget limit has been met. At that point, overflow parameter is applied (680) to the other dayparts, assuming enough inventory exists. For example, if AM Drive runs out of inventory, the overflow is applied to the Afternoon slot and PM Drive to determine a cap for each. This means that afternoon is caped at 11% and PM Drive is capped at 44%. The number of impressions needed to reach these caps are determined and the determined number of impressions are obtained as long as budget is not exceeded.

For the next (third) distribution, assume that 200,000 additional impressions are obtained (670) for the PM Drive to bring up the total to 300,000. The distribution after the third distribution is ˜42.85% for AM Drive, ˜14.28% for Afternoon, and ˜42.86% for the PM Drive.

For the next (fourth) distribution, the AM Drive is identified (650) as being farthest away from the requested percentage distribution. Assume that additional 150,000 impressions are obtained (670) for the AM Drive to bring up the total to 450,000. The obtained percentage distribution after the fourth distribution is ˜52.94% for AM Drive, ˜11.76% for Afternoon, and ˜35.29% for PM Drive.

For the next (fifth) distribution, the PM Drive is identified (650) as being farthest away from the requested percentage distribution (40%). Assume that 100,000 additional impressions are obtained (670) for the PM Drive to bring up the total to 400,000. The obtained percentage distribution after the fifth distribution is ˜47.37% for AM Drive, ˜10.52% for Afternoon, and ˜42.1% for PM Drive.

For the next (sixth) distribution, AM Drive is identified (650) as being farthest away from the requested distribution (50%). Assume that additional 50,000 impressions are obtained (670) for the AM Drive to bring up the total to 500,000 impressions. No more inventory exists (660) for the AM Drive, and thus overflow is activated (680). For Afternoon, the overflow of 10% ensures that the maximum allowed is 11% of the total impressions. For PM Drive, the overflow of 10% ensures that the maximum allowed is 44% of the total impressions. At this point, these maximum allowed impressions are checked against the set budget to determine whether how much they can be filled. Before applying overflow, the obtained distribution is 500,000 impressions (50%) for AM Drive, 100,000 impressions (10%) for Afternoon, and 400,000 (40%) for PM Drive. Since the desired target distribution has been reached, the overflow need not be applied. However, the overflow can be applied to maximize the set budget.

Again, the daypart that is furthest away from the required percentage is identified. Since both Afternoon and PM Drive are equally close to the requested percentage, either one can be selected first. Assume that PM Drive is selected. To reach the overflow allowed 44% for the PM Drive, approximately 70,000 additional impressions are obtained. Next, the Afternoon slot is selected as the daypart farthest away from the requested percentage. To reach the overflow allowed 11% for the Afternoon slot, approximately 20,000 additional impressions are obtained for the Afternoon slot.

The final actual percentage distribution obtained is ˜45.9% for the AM Drive, ˜11% for the Afternoon slot, and ˜43.1% for the PM Drive. In this manner, the obtained percentage distribution is closer to the requested percentage distribution. However, the tradeoff is that the total number of impressions actually obtained may be less than the requested total number of distribution. In the above example, the total impressions obtained for all three impressions combined is 1,090,000 impressions. Since 2,000,000 impressions were budgeted, 950,000 less impressions have been obtained. Thus, process 600 is preferred when the advertiser requested distribution is more important than maximizing the budget. The advertiser 224 can be provided with an option to decide which is more important, maximizing the budget or staying within the requested distribution. Based on the decision, either process 400 or process 600 can be implemented.

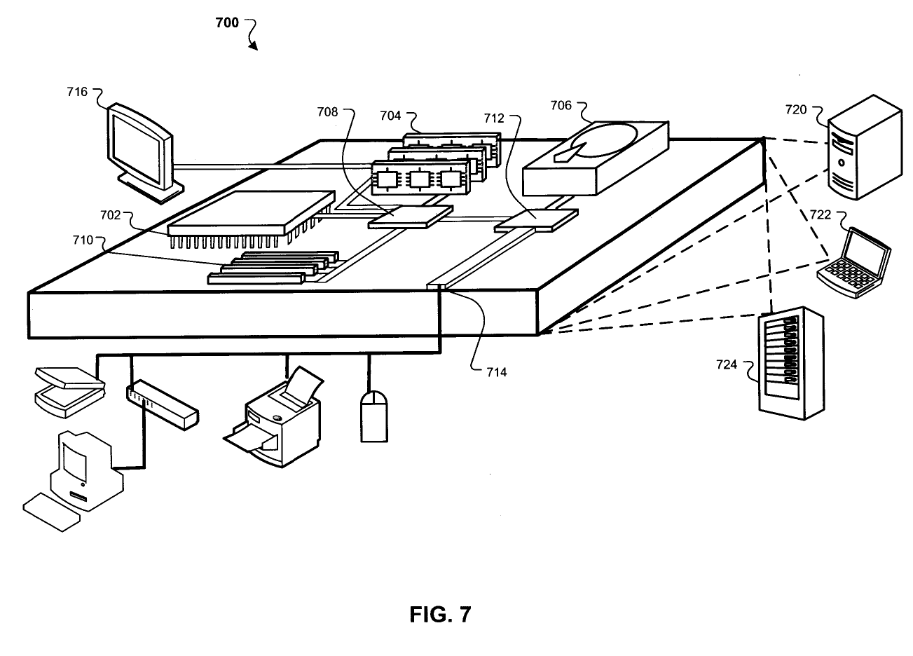

FIG. 7 is a block diagram of a computing device and system that can be used, e.g., to implement non-uniform distribution of impressions. Computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and can be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses can be used, as appropriate, along with multiple memories and types of memory. Also, multiple computing devices 700 can be connected, with each device providing portions of the necessary operations (e.g., as a server bank, a group of blade servers, or a multi-processor system).

The memory 704 stores information within the computing device 600. In one implementation, the memory 704 is a computer-readable medium. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 can be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, memory on processor 702, or a propagated signal.

The high speed controller 708 manages bandwidth-intensive operations for the computing device 700, while the low speed controller 712 manages lower bandwidth-intensive operations. Such allocation of duties is exemplary only. In one implementation, the high-speed controller 708 is coupled to memory 704, display 716 (e.g., through a graphics processor or accelerator), and to high-speed expansion ports 710, which can accept various expansion cards (not shown). In the implementation, low-speed controller 712 is coupled to storage device 706 and low-speed expansion port 714. The low-speed expansion port, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 700 can be implemented in a number of different forms, as shown in the figure. For example, it can be implemented as a standard server 720, or multiple times in a group of such servers. It can also be implemented as part of a rack server system 724. In addition, it can be implemented in a personal computer such as a laptop computer 722.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “information carrier” comprises a “machine-readable medium” that includes any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

A number of implementations of the disclosure has been described. Nevertheless, it will be understood that various modifications may be made without departing from the scope of the disclosure including the claims.

What is claimed is:

1. A computer-implemented method comprising:
generating a target number of advertising impressions for one or more advertising categories based, at least in part, on a non-uniform percentage distribution of advertising impressions for an advertising campaign, the percentage distribution corresponding to the one or more advertising categories;
determining whether enough advertising inventory is available to fulfill the target number of advertising impressions; and
when a shortage of available inventory is detected in the one or more advertising categories, generating an actual number of advertising impressions for the one or more advertising categories.

2. The method of claim 1, further comprising obtaining the non-uniform percentage distribution of advertising impressions from an advertiser.

3. The method of claim 1, wherein generating the actual number of advertising impressions for the one or more advertising categories comprises modifying the non-uniform percentage distribution based on an overflow parameter.

4. The method of claim 3, further comprising obtaining the overflow parameter from an advertiser.

5. The method of claim 1, further comprising:
comparing the target number against the actual number of advertising impressions; and
based on the comparison, applying at least one compensation scheme to minimize a difference between the target number and the actual number.

6. The method of claim 5, wherein applying at least one compensation scheme comprises at least one of:
setting the target number of impressions as a maximum number of target impressions;
modifying the non-uniform percentage distribution; and
reducing a maximum number of target impressions.

7. The method of claim 2, wherein the obtaining a non-uniform percentage distribution corresponding to one or more advertising categories comprises:
enabling the advertiser to select the one or more advertising categories from a group that includes station tiers, station formats, listener demographics, geographical markets, dayparts, and days of a week; and
enabling the advertiser to select the non-uniform percentage distribution that corresponds to the selected one or more advertising categories.

8. The method of claim 7, wherein enabling the advertiser to select the one or more advertising categories from a group that includes geographical markets, dayparts, and days of a week comprises:
enabling the advertiser to select one geographical market and two or more dayparts for the selected geographical market; or
enabling the advertiser to select two or more geographical markets and one or more dayparts for each selected geographical market.

9. The method of claim 8, further comprising enabling the advertiser to select one or more days of a week for each selected geographical market.

10. The method of claim 1, further comprising:
reserving an initial number of impressions for each advertising category, wherein the initial number is less than the target number; and
incrementally increasing the initial number until the shortage in inventory is detected or the target number is reached.

11. A system comprising:
a user input device; and
one or more computer systems coupled to the user input device, the one or more computer systems including a display and a processor configured to provide a graphical user interface that includes
an input selector operable to obtain a user selection of one or more advertising categories and a non-uniform percentage distribution of advertising impressions for an advertising campaign, the obtained percentage distribution corresponding to the selected one or more advertising categories; and
a display region operable to display a target number of advertising impressions generated for the one or more advertising categories based, at least in part, on the obtained percentage;
wherein the one or more computer systems are configured to
determine whether enough advertising inventory is available to fulfill the target number of advertising impressions; and
when a shortage of available inventory is detected in the one or more advertising categories, generate an actual number of advertising impressions for the one or more advertising categories.

12. The system of claim 11, wherein
the input selector of the graphical user interface is further operable to obtain a overflow parameter that modifies the non-uniform percentage distribution when activated; and
the one or more computer systems are further configured to
detect a shortage of available advertising inventory in the one or more advertising categories;
activate the obtained overflow parameter to modify the non-uniform percentage distribution based on the detected shortage; and
generate the actual number of advertising impressions based on the modified non-uniform percentage distribution.

13. The system of claim 11, wherein the one or more computer systems are further configured to
compare the target number against the actual number of advertising impressions; and
based on the comparison, apply at least one compensation scheme to minimize a difference between the target number and the actual number.

14. The system of claim 13, wherein the one or more computer systems are configured to apply the at least one compensation scheme by performing at least one of:
setting the target number of impressions as a maximum number of target impressions;
modifying the non-uniform percentage distribution; and
reducing a maximum number of target impressions.

15. The system of claim 11, wherein the input selector of the graphical user interface is further operable to:
receive advertiser selection of the one or more advertising categories from a group that includes geographical markets, station tiers, station formats, listener demographics, dayparts, and days of a week; and
receive advertiser selection of the non-uniform percentage distribution that corresponds to the selected one or more advertising categories.

16. The system of claim 11, wherein the input selector of the graphical user interface is further operable to receive advertiser selection of one geographical market and two or more dayparts for the selected geographical market; or receive advertiser selection of two or more geographical markets and one or more dayparts for each selected geographical market.

17. The system of claim 16, wherein the input selector of the graphical user interface is further operable to receive advertiser selection of one or more days of a week for each selected geographical market.

18. The system of claim 11, wherein the one or more computer systems are configured to:
reserving an initial number of impressions for each advertising category, wherein the initial number is less than the target number; and
incrementally increasing the initial number until the shortage in inventory is detected or the target number is reached.

19. A computer program product, embodied on a computer-readable medium, operable to cause a data processing apparatus to perform operations comprising:
generating a target number of advertising impressions for one or more advertising categories based, at least in part, on a non-uniform percentage distribution of advertising impressions for an advertising campaign, the percentage distribution corresponding to the one or more advertising categories;
determining whether enough advertising inventory is available to fulfill the target number of advertising impressions; and
when a shortage of available inventory is detected in the one or more advertising categories, generating an actual number of advertising impressions for the one or more advertising categories.

20. The computer program product of claim 19, further operable to cause the data processing apparatus to obtain the non-uniform percentage distribution of advertising impressions from an advertiser.

21. The computer program product of claim 20, further operable to cause the data processing apparatus to obtain the non-uniform percentage distribution of advertising impressions from the advertiser comprising:
enabling the advertiser to select the one or more advertising categories from a group that includes geographical markets, station tiers, station format, listener demographics, dayparts, and days of a week; and
enabling the advertiser to select the non-uniform percentage distribution that corresponds to the selected one or more advertising categories.

22. The computer program product of claim 21, further operable to cause the data processing apparatus to
enable the advertiser to select one geographical market and two or more dayparts for the selected geographical market; or
enable the advertiser to select two or more geographical markets and one or more dayparts for each selected geographical market.

23. The computer program product of claim 22, further operable to cause the data processing apparatus to enable the advertiser to select one or more days of a week for each selected geographical market.

24. The computer program product of claim 19, further operable to cause the data processing apparatus to
generate the actual number of advertising impressions for the one or more advertising categories by modifying the non-uniform percentage distribution based on an overflow parameter.

25. The computer program product of claim 19, further operable to cause the data processing apparatus to
compare the target number against the actual number of advertising impressions; and
based on the comparison, apply at least one compensation scheme to minimize a difference between the target number and the actual number.

26. The computer program product of claim 25, further operable to cause the data processing apparatus to apply the at least one compensation scheme by performing at least one of
setting the target number of impressions as a maximum number of target impressions;
modifying the non-uniform percentage distribution; and
reducing a maximum number of target impressions.

27. The computer program product of claim 19, further operable to cause the data processing apparatus to perform operations comprising:
reserving an initial number of impressions for each advertising category, wherein the initial number is less than the target number; and
incrementally increasing the initial number until the shortage in inventory is detected or the target number is reached.

28. A method comprising:
obtaining data associated with an advertising campaign, wherein the data includes at least a budget and a non-uniform percentage distribution of advertising impressions corresponding to one or more advertising categories;
reserving an initial number of advertising impressions for the one or more advertising categories;
incrementally increasing the initial number to obtain the non-uniform percentage distribution until the budget is reached or a shortage of inventory is detected.

29. The method of claim 28, further comprising applying an overflow parameter when the shortage of inventory is detected.

30. A system comprising:
a display means for presenting a graphical user interface operable to
obtain a user selection of one or more advertising categories;
obtain a non-uniform percentage distribution of advertising impressions for each selected advertising categories in an advertising campaign; and
display a target number of advertising impressions generated for the one or more advertising categories based, at least in part, on the specified percentage; and
one or more computing means for
determining whether enough advertising inventory is available to fulfill the target number of advertising impressions, and
when a shortage of available inventory is detected in the one or more advertising categories, generating an actual number of advertising impressions for the one or more advertising categories.
